(19) United States
(12) Patent Application Publication
(10) Pub. No.: US 2019/0213703 A1
(43) Pub. Date: Jul. 11, 2019

(54) SYSTEMS AND METHODS FOR IDENTIFYING UNIDENTIFIED AUTONOMOUS VEHICLES

(71) Applicant: Walmart Apollo, LLC, Bentonville, AR (US)

(72) Inventors: David C. Winkle, Bella Vista, AR (US); Nathan G. Jones, Bentonville, AR (US); Michael D. Atchley, Eureka Springs, AR (US)

(21) Appl. No.: 16/243,885

(22) Filed: Jan. 9, 2019

Related U.S. Application Data
(60) Provisional application No. 62/615,672, filed on Jan. 10, 2018.

(51) Int. Cl. G06Q 50/28; B64D 1/08; B64C 39/02; G05D 1/12; G08G 5/00; B64D 45/00; G05D 1/10

(52) U.S. Cl. CPC G06Q 50/28; B64D 1/08; B64C 39/024; G05D 1/12; G08G 5/0078; B64D 2045/0045; B64D 45/0015; G08G 5/0039; G08G 5/0069; G05D 1/101; B64C 2201/128; G08G 5/0043

(57) ABSTRACT

In some embodiments, apparatuses and methods are provided herein useful to identifying and evaluating an unidentified autonomous vehicle (AV) during a retail product delivery. In some embodiments, there is provided a system for identifying and evaluating an unidentified AV including a first identified AV configured to transport one or more retail products comprising: a plurality of sensors configured to provide sensor data used to determine patterns of movement of AVs over a time period; and an AV control circuit configured to: receive the sensor data; determine one or more patterns of movement of an unidentified AV based on the sensor data; determine whether the one or more patterns of movement of the unidentified AV is inconsistent with one or more sets of expected patterns of movement of the plurality of identified AVs; and identify that the unidentified AV is not associated with a retail store.

### CROSS-REFERENCE TO RELATED APPLICATION(S)

This application claims the benefit of U.S. Provisional Application No. 62/615,672 filed Jan. 10, 2018, which is incorporated herein by reference in its entirety.

### TECHNICAL FIELD

This invention relates generally to identifying autonomous vehicles.

### BACKGROUND

Commercial use of drones is growing. Generally, drones are used inside a commercial space where each drone is identified as part of machines used in a facility operated by a retail store. Outside the commercial space, drones may have to operate in a space where other unidentified drones may also operate.

### BRIEF DESCRIPTION OF THE DRAWINGS

Disclosed herein are embodiments of systems, apparatuses and methods pertaining to identifying and evaluating an unidentified autonomous vehicle. This description includes drawings, wherein:

FIG. 1 illustrates a simplified block diagram of an exemplary system for identifying and evaluating an unidentified autonomous vehicle in accordance with some embodiments;

FIG. 2 shows a flow diagram of an exemplary process of identifying and evaluating an unidentified autonomous vehicle in accordance with some embodiments;

FIG. 3 shows a flow diagram of an exemplary process of identifying and evaluating an unidentified autonomous vehicle in accordance with some embodiments;

FIG. 4 shows a flow diagram of an exemplary process of identifying and evaluating an unidentified autonomous vehicle in accordance with some embodiments;

FIG. 5 shows a flow diagram of an exemplary process of identifying and evaluating an unidentified autonomous vehicle in accordance with some embodiments;

FIG. 6 shows a flow diagram of an exemplary process of identifying and evaluating an unidentified autonomous vehicle in accordance with some embodiments; and

FIG. 7 illustrates an exemplary system for use in implementing methods, techniques, devices, apparatuses, systems, servers, sources, and identification and evaluation of an unidentified autonomous vehicle, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for identifying and evaluating an unidentified autonomous vehicle. In some embodiments, a retail delivery control system for identifying and evaluating an unidentified autonomous vehicle during a retail product delivery includes a first identified autonomous vehicle (AV) of a plurality of identified AVs. In one configuration, the first identified AV may transport one or more retail products associated with a retail store to a delivery destination within a delivery period. By one approach, the one or more retail products may be associated with a customer order. By another approach, the first identified AV may include a plurality of sensors configured to provide sensor data used to determine patterns of movement of AVs over a time period within the delivery period. By another approach, the first identified AV may include an AV control circuit coupled with the plurality of sensors. In one configuration, the AV control circuit may receive the sensor data. In another configuration, the AV control circuit may determine one or more patterns of movement of an unidentified AV based on the sensor data. By one approach, the AV control circuit may determine whether the one or more patterns of movement of the unidentified AV is inconsistent with one or more sets of expected patterns of movement of the plurality of identified AVs. In such an approach, the plurality of identified AVs may be associated with the retail store. In yet another configuration, the AV control circuit may identify that the unidentified AV is not associated with the retail store based on the determination that the one or more patterns of movement of the unidentified AV is inconsistent with the one or more sets of expected patterns of movement of the plurality of identified AVs.

In some embodiments, a method for identifying and evaluating an unidentified autonomous vehicle during a retail product delivery includes determining, by a first identified autonomous vehicle (AV) of a plurality of identified AVs, one or more patterns of movement of an unidentified AV based on sensor data received from a plurality of sensors. By one approach, the first identified AV may transport one or more retail products associated with a retail store to a delivery destination within a delivery period. By another approach, the one or more retail products may be associated with a customer order. In one configuration, the method may include determining, by the first identified AV, whether the one or more patterns of movement of the unidentified AV is inconsistent with one or more sets of expected patterns of movement of a plurality of identified AVs. In such a configuration, the plurality of identified AVs may be associated with the retail store. In yet another configuration, the method may include identifying, by the first identified AV, that the unidentified AV is not associated with the retail store based on the determination that the one or more patterns of movement of the unidentified AV is inconsistent with the one or more sets of expected patterns of movement of the plurality of identified AVs.

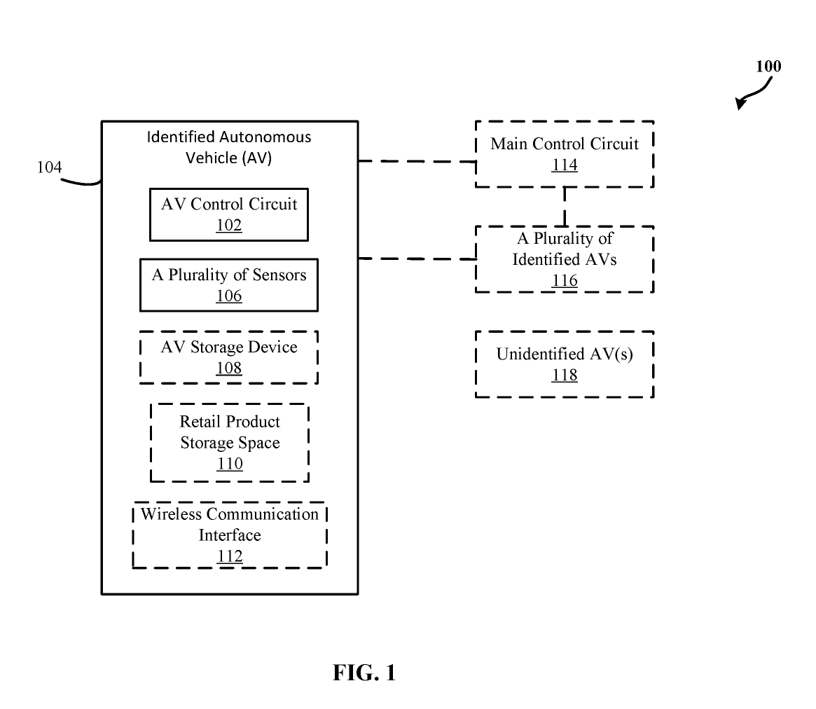

FIG. 1 illustrates a simplified block diagram of an exemplary system 100 for identifying and evaluating an unidentified autonomous vehicle in accordance with some embodiments. The system 100 includes a first identified autonomous vehicle (AV) 104. In one configuration, the first identified AV 104 may include an AV control circuit 102. In another configuration, the first identified AV 104 may include at least one sensor and/or a plurality of sensors 106. The plurality of sensors 106 may be coupled with the AV control circuit 102. By one approach, the sensors may be coupled with the AV control circuit 102. As such, any references, functionalities, and/or descriptions described herein that pertain to the plurality of sensors 106 are also applicable to the at least one sensor. Thus, in some configurations, the first identified AV 104 may include a sensor having similar functionalities referenced and/or described herein as of those of one or more of the plurality of sensors 106. In one example, the plurality of sensors 106 may include speed sensor, sound sensor, environmental sensor, weather sensor, moisture sensor, humidity sensor, acceleration sensor, distance sensor, navigation and/or location sensor, optical sensor, light sensor, imaging sensor, temperature sensor, thermal sensor, proximity sensor, sonar sensor, wireless triangulation sensor, LIDAR (Light Detection and Ranging) and/or radio frequency sensor, among other types of sensors configured to determine shapes and patterns of movement of an AV, recognize symbols, characters, and/or numbers, and/or receive signal and/or data communications from one or more AVs.

In another configuration, the first identified AV 104 may include an AV storage device 108. By one approach, the AV storage device 108 may be coupled and/or accessed by the AV control circuit 102. In one example, the AV storage device 108 may include a Random Access Memory (RAM), a Read Only Memory (ROM), a cloud-based storage, among other types of memory storages that are tangible and non-transient. By another approach, the first identified AV 104 may include a retail product storage space 110. The retail product storage space 110 may store one or more retail products while in transit for delivery to one or more delivery destinations. In yet another example, the first identified AV 104 may include a transport mechanism. The transport mechanism may be configured to move the first identified AV 104 from one location and/or area to another location and/or area via ground, water, and/or air. By one approach, the first identified AV 104, the plurality of identified AVs 116, and/or the unidentified AV(s) 118 may include autonomous ground vehicles, autonomous aerial vehicles, autonomous water vehicles, or one or more combinations thereof.

In some embodiments, the system 100 may include a main control circuit 114. In one configuration, the first identified AV 104 may be communicatively coupled with the main control circuit 114 via a wireless communication interface 112. In another configuration, the plurality of identified AVs 116 and/or unidentified AV(s) 118 may be communicatively coupled with the first identified AV 104 via the wireless communication interface 112. In yet another configuration, the plurality of identified AVs 116 may be communicatively coupled to the main control circuit 114. In such configurations, the wireless communication interface 112 may include one or more wireless transmitters, receivers, and/or transceivers. By one approach, the wireless communication interface 112 may be configured to work with one or more IEEE (Institute of Electrical and Electronics Engineers) standard wireless protocols and/or proprietary wireless protocols.

As an illustrative non-limiting example, the first identified AV 104 of a plurality of identified AVs may transport one or more retail products associated with a retail store to a delivery destination within a delivery period. By one approach, the one or more retail products may be associated with one or more customer orders. In one example, the plurality of sensors 106 may provide sensor data used by the AV control circuit 102 to determine patterns of movement of other AVs 116, 118 that are within sensor distance of the one or more sensors 106 of the first identified AV 104 over a time period. By one approach, the time period may be a period of time within the delivery period. By another approach, the time period may start at a time and/or prior to a threshold of time the sensor data is received by the AV control circuit 102. In one configuration, the time period may end at a time and/or after a threshold of time the sensor data is no longer being received by the AV control circuit 102. As an illustrative non-limiting example, the first identified AV 104 may receive a mission data from the main control circuit 114 and/or the plurality of identified AVs 116. The mission data may include one or more delivery destinations based on one or more customer orders. Retail products associated with the one or more customer orders may be delivered within the delivery period indicated by the mission data. In one configuration, the first identified AV 104 may receive the sensor data from the one or more sensors 106 as the first identified AV is performing a delivery of one or more products. By one approach, the receipt of sensor data may be triggered by a presence of the unidentified AV(s) 118 and/or the plurality of identified AVs 116. In one example, the presence may correspond to the unidentified AV(s) 118 and/or the plurality of identified AVs 116 being within sensor distance of the one or more sensors 106 of the first identified AV 104 and/or being a threshold distance from the first identified AV 104. In another example, the first identified AV 104 may determine that the sensor data corresponds to the unidentified AV(s) 118 and/or the plurality of identified AVs 116 based on a receipt of radio frequency signals particular to the unidentified AV(s) 118 and/or the plurality of identified AVs 116. In one configuration, the AV control circuit 102 may determine one or more patterns of movement of the unidentified AV(s) 118 based on the sensor data. In one example, the AV control circuit 102 may perform image processing and/or signal processing on the sensor data received from the plurality of sensors 106 to determine the one or more patterns of movement of the unidentified AV(s) 118. In one example, the one or more patterns of movement may be determined based, at least in part, on at least one of direction of movement of the unidentified AV(s) 118, observed and/or estimated travel path or path of transport of the unidentified AV(s) 118, speed and/or acceleration of the movement of the unidentified AV(s) 118, and/or proximity of the unidentified AV(s) 118 to the first identified AV 104 and/or a point of interest to name a few. The point of interest may include a park, a tourist destination, an airport, a mall, a business area, a residential neighborhood, a highway, a body of water (e.g., lake, ocean, river, etc.), among other types of points of interest associated with a usage of the unidentified AV(s) 118 by a user and/or a retail store associated with the first identified AV 104.

In another configuration, the AV control circuit 102 may determine whether the one or more patterns of movement of the unidentified AV(s) 118 is inconsistent with the one or more sets of expected patterns of movement of the plurality of identified AVs 116. By one approach, the plurality of identified AVs may be associated with a retail store and/or the first identified AVs 104. By another approach, the one or more patterns of movement associated with the AVs associated with the retail store and/or the first identified AVs 104 may include patterns of movement resulting from execution of one or more mission data provided by the main control circuit 114 and/or delivery of retail products ordered by one or more customers of the retail store. Alternatively or in addition to, the one or more sets of expected patterns of movement of the plurality of identified AVs 116 may be based on stored sets of expected patterns of movement in the AV storage device 108. In one configuration, the stored sets of expected patterns of movement may be based on delivery path generally taken by the plurality of identified AVs 116, predetermined and/or configured behavior associated with the plurality of identified AVs 116, and/or historical pattern of movements performed by the plurality of identified AVs 116 during a delivery and/or avoidance of no-fly zones, among other types of patterns recognized by the first identified AV 104 as patterns generally attributable to AVs associated with the first identified AV 104 and/or the retail store. By one approach, the predetermined and/or configured behavior may include one or more predetermined cruising speed, acceleration, safe travel distance, travel direction, and/or maneuver patterns of the plurality of identified AVs 116.

By one approach, the AV control circuit 102 may access the AV storage device 108 to determine whether the one or more patterns of movement of the unidentified AV(s) 118 may be inconsistent with the one or more sets of expected patterns of movement of the plurality of identified AVs 116. In one configuration, the access to the AV storage device 108 by the AV control circuit 102 may be in response to the receipt of the sensor data. In another configuration, the access may be triggered by a determination that a response signal has not been received from the unidentified AV(s) 118 after a threshold of wait time subsequent to the AV control circuit 102 providing an identify signal to the unidentified AV(s) 118. In one scenario, the identify signal may correspond to a beacon signal. In another configuration, the determination that the response signal has not been received from the unidentified AV(s) 118 after the threshold of wait time may be used by the AV control circuit 102 to identify that the unidentified AV(s) 118 is not associated with the retail store.

In some embodiments, the AV control circuit 102 may identify that the unidentified AV(s) 118 may not be associated with the retail store based on a determination that one or more patterns of movement of the unidentified AV(s) 118 is inconsistent with one or more sets of expected patterns of movement of the plurality of identified AVs 116. By one approach, the AV control circuit 102, in the determination of the one or more patterns of movement of the unidentified AV(s) 118, may determine a speed of the unidentified AV(s) 118 based on speed data received over a time period from one or more sensors of the plurality of sensors 106. For example, the one or more sensors may include speed sensors. Alternatively or in addition to, the AV control circuit 102 may determine a direction of the unidentified AV(s) 118 based on location data and the speed data received over a time period. In one example, the location data may be provided by one or more of the plurality of sensors 106 (e.g., a navigation and/or location sensor among other sensors in the plurality of sensors 106). Further, in some applications, the AV control circuit 102 can receive sensor data to track movement of the unidentified AV(s) 118 relative to movement of the first identified AV 104 and determine at least speed and/or movement indicating the unidentified AV(s) 118 is predicted to be within a threshold distance of the first identified AV 104.

In an illustrative non-limiting example, the first identified AV 104 may be en route to one of delivery destinations associated with a delivery mission received from the main control circuit 114. While travelling on a path generally traveled by the plurality of identified AVs 116 and/or associated with one or more routes to the delivery destination associated with a customer order, the AV control circuit 102 may receive sensor data provided by the plurality of sensors 106. In one example, the plurality of sensors 106 may include a speed sensor configured to provide speed data of the unidentified AV and/or a location sensor configured to provide location data of the unidentified AV. In such an example, the sensor data received by the AV control circuit 102 may include the speed data and/or the location data. In another example, the location sensor may include Global Positioning System (GPS), Galileo satellite system, Global Navigation Satellite System (GLONASS), and/or other types of satellite navigation systems that are configured to provide location coordinates. By one approach, the location data may include the location coordinates provided by one of the location sensors and/or a location of the unidentified AV(s) 118 relative to the first identified AV 104 (e.g., distance from, angle relative to direction of travel, estimated altitude of the unidentified AV(s) 118, among other ways to represent a location of the unidentified AV(s) 118. In another example, the location data of the unidentified AV(s) 118 may be based on location coordinate of the first identified AV 104 and the speed data of the unidentified AV(s) 118. By one approach, the speed sensor and the location sensor may be used by the AV control circuit 102 to determine the location data of the unidentified AV(s) 118.

By one approach, based on the sensor data, the AV control circuit 102 may determine that the unidentified AV(s) 118 may be moving in a zigzagging pattern (e.g., erratic patterns or movements, repeatedly crossing an intended route of the first identified AV 104, repeatedly approaching the first identified AV 104, changes in altitude a threshold number of times within a threshold period of time, and/or other such movements of the unidentified AV(s) 118. In some embodiments, the sensor data corresponding to one or more unidentified AV(s) is tracked over time, and movements of the unidentified AV(s) can be identified as potentially harmful or threatening to the first identified AV 104. In one configuration, the AV control circuit 102 may compare the detected movement over time of the unidentified AV(s) 118 (e.g., zigzagging pattern) with one or more sets of expected patterns of movement stored in the AV storage device 108. Based on the comparison, the AV control circuit 102 may determine that the detected movement and/or zigzagging pattern of the unidentified AV is inconsistent with the one or more sets of expected patterns of movement associated with the plurality of identified AVs 116. In response, the AV control circuit 102 may identify that the unidentified AV(s) 118 is not associated with the first identified AV 104 and/or an operator or owner of the first identified AV 104 (e.g., a retail store). In one scenario, the retail store may be associated with the plurality of identified AVs 116. For example, the plurality of identified AVs 116 may be owned and operated by the retail store to make deliveries of products purchased by customers, may be operated by a third party service contracted by the retailer in implementing deliveries of products, or the like.

Alternatively or in addition to, the AV control circuit 102 may provide an identify signal to the unidentified AV(s) 118. In one example, the identify signal may be transmitted through the wireless communication interface 112. By one approach, the identify signal may be sent by the first identified AV 104 to determine whether the unidentified AV(s) 118 is associated with one or more delivery missions provided by the main control circuit 114 and/or customer orders received by a retail store associated with the first identified AV 104. In one configuration, the AV control circuit 102 may determine whether a response signal is received through the wireless communication interface 112. In such a configuration, an identification by the AV control circuit 102 that the unidentified AV(s) 118 is not associated with the retail store may be based on the determination that the response signal is not received. In another configuration, the AV control circuit 102 may determine that the unidentified AV(s) 118 is not associated with the retail store based on a determination that one or more patterns of movement of the unidentified AV(s) 118 is inconsistent with one or more sets of expected patterns of movement of the plurality of identified AVs 116 and the non-receipt of the response signal from the unidentified AV(s) 118. In another configuration, the AV control circuit 102 may provide the identify signal to the unidentified AV(s) 118 as an additional verification, in addition to the determination of the inconsistency of the one or more patterns of movement, that the unidentified AV(s) 118 is not associated with the retail store and/or the first identified AV 104. By one approach, the additional verification may only be executed and/or performed when the AV control circuit 102 determines that the one or more patterns of movement of the unidentified AV(s) 118 is less than a matching threshold with the one or more sets of expected patterns of movement of the plurality of identified AVs 116. Alternatively or in addition to, the AV control circuit 102 may identify that the unidentified AV(s) 118 is not associated with the retail store based on a shape of the unidentified AV(s) 118, a symbol associated with the unidentified AV(s) 118, a communication response from the unidentified AV(s) 118, and/or a recognition of one or more characters on the unidentified AV(s) 118. For example, the AV control circuit 102 may perform data processing and/or image processing on the sensor data to determine the shape of the unidentified AV(s) 118, one or more symbols and/or the one or more characters on a surface of the unidentified AV(s) 118 and/or something carried by the unidentified AV(s), such as a package, transport container, etc. In identifying the unidentified AV(s) 118, the AV control circuit 102 may compare the shape, the one or more symbols and/or the one or more characters with shape, symbols, and/or characters associated with the plurality of identified AVs 116 that are stored in the AV storage device 108 and/or a storage device associated with the main control circuit 114. Based on the comparison, when the AV control circuit 102 determines that at least one of: the shape, the one or more symbols and/or the one or more characters matches within a threshold with shape, symbols, and/or characters associated with the plurality of identified AVs 116, the AV control circuit 102 may provide the identify signal to the unidentified AV(s). By one approach, when the AV control circuit 102 does not receive a response signal from the unidentified AV(s) 118, the AV control circuit 102 may determine that the unidentified AV(s) 118 is not associated with the retail store and/or the first identified AV 104. By another approach, when the AV control circuit 102 receives the response signal, the AV control circuit 102 may determine that the unidentified AV(s) 118 is associated with the retail store and/or the first identified AV 104 and may now designate the unidentified AV(s) 118 as one of the plurality of identified AVs 116. Alternatively or in addition to, when the AV control circuit 102 determines that at least one of: the shape, the one or more symbols and/or the one or more characters does not match within the threshold with shape, symbols, and/or characters associated with the plurality of identified AVs 116, the AV control circuit 102 may determine that the unidentified AV(s) 118 is not associated with the retail store and/or the first identified AV 104.

In some embodiments, the first identified AV 104 may identify the unidentified AV(s) 118 based on speed and direction of the unidentified AV(s) 118. In one configuration, the AV control circuit 102 may determine whether the speed of the unidentified AV(s) 118 is within a threshold of a cruising speed. In one example, the cruising speed may correspond to general speed predetermined and/or configured to the plurality of identified AVs 116 when the plurality of identified AVs 116 are en route to delivery destinations associated with transported retail products, returning from a delivery, traveling to perform a pickup of an item, performing other assigned tasks, or the like. In another example, the cruising speed may include a predetermined speed corresponding to a movement associated with at least one expected pattern of the one or more sets of expected patterns of movement of the plurality of identified AVs 116. Alternatively or in addition to, the AV control circuit 102 may determine whether the direction of the unidentified AV(s) 118 is within a threshold distance of a flight path and/or a travel path associated with a delivery period. For example, each delivery mission provided to the plurality of identified AVs 116 may include a safe travel distance between two or more identified AVs of the plurality of identified AVs 116 traveling on the flight and/or travel path and/or the threshold distance to travel within the flight and/or travel path and/or proximate the flight and/or travel path. By one approach, one or more information included in each of the delivery mission may be associated with one or more sets of expected patterns of movement of the plurality of identified AVs 116. In such an example, when the direction of travel of the unidentified AV(s) 118 is not within a threshold distance based on the delivery mission of a corresponding identified AV and/or the one or more sets of expected patterns of movement of the plurality of identified AVs 116, the AV control circuit 102 may determine that the one or more patterns of movement of the unidentified AV(s) 118 is inconsistent based on the determination of the speed and the direction of the unidentified AV(s) 118.

In yet some embodiments, the AV control circuit 102 may determine at least one countermeasure response of a set of countermeasure responses relative to at least one behavior of a set of one or more behaviors of the unidentified AV(s) 118 based on the identification that the unidentified AV is not associated with a retail store associated with the first identified AV 104 and/or the plurality of identified AVs 116. By one approach, the at least one countermeasure response may include one or more actions performed by the first identified AV 104 to avoid the unidentified AV(s) 118, remove a threat exhibited by the unidentified AV(s) 118, and/or increase awareness of the unidentified AV(s) 118, among other types of countermeasure responses that the first identified AV 104 may perform to ensure on-time and/or safe delivery of transported retail products by the first identified AV 104 and/or the plurality of identified AVs 116 during a delivery period and/or future delivery missions. In one example, the set of one or more behaviors of the unidentified AV(s) 118 may include the unidentified AV(s) 118 intersecting with a flight and/or travel path associated with a delivery period, the unidentified AV(s) 118 following and alongside a threshold distance from the flight and/or travel path, causing the first identified AV 104 to delay delivery to a delivery destination due to the unidentified AV(s) 118 substantially hovering over the flight and/or travel path and proximate to the delivery destination, and the unidentified AV(s) 118 being less than a safe threshold distance from the first identified AV 104. In another example, the set of one or more behaviors of the unidentified AV(s) 118 may include the unidentified AV(s) 118 carrying an unidentifiable tool or package and/or detaching an object at an improbable location (e.g., a dumpster, a school roof, etc.).

In yet some embodiments, the AV control circuit 102 may, in the determination of the at least one countermeasure response, provide an alert message to the main control circuit 114. Alternatively or in addition to, one of the plurality of sensors 106 of the AV control circuit 102 may emit an alarm signal. In one example, the alarm signal may be audible. In another example, the alarm signal may be an electronic signal receivable by at least one of the plurality of identified AVs 116 that is within a threshold distance from the first identified AV 104. Alternatively or in addition to, the AV control circuit 102 may request modification of a portion of a flight and/or travel path associated with a delivery period to the main control circuit 114. For example, the portion requested to be modified may correspond to a location and/or an area where the unidentified AV(s) 118 is identified. In another configuration, the AV control circuit 102 may initiate landing of the first identified AV 104 on an AV landing site associated with the retail store as a counter measure response to at least one behavior exhibited by the unidentified AV(s) 118. For example, the main control circuit 114 may be remote from and in wireless communication with the first identified AV 104 and may provide a first mission (e.g., the delivery mission or the mission data) to the first identified AV 104 via the wireless communication interface 112. In response to an alert message received from the first identified AV 104, the main control circuit 114 may provide a deviation flight and/or travel path as a countermeasure response to be executed by the AV control circuit 102. By one approach, the deviation flight and/or travel path may correspond to a portion of the flight and/or travel path modified by the main control circuit 114 based on the modification request received from the first identified AV 104. In some embodiments, the location and/or the area where the unidentified AV(s) 118 is identified, the determined inconsistent pattern(s) that are associated with the unidentified AV(s) 118, the speed, the shape, the one or more symbols, and/or the one or more characters associated with the unidentified AV(s) 118 may be stored in the AV storage device 108 to aid in faster identification of the unidentified AV(s) 118 in a future encounter. For example, the first identified AV 104 may initially determine the unidentified AV(s) 118 based on a correlation of one or more of information previously stored in the AV storage device 108 of previous encounters and/or determination of the unidentified AV(s) 118.

Alternatively or in addition to, in response to the identification that the unidentified AV(s) 118 is not associated with the retail store, the AV control circuit 102 may register an identifier of the unidentified AV(s) 118 in an unexpected pattern database. In one example, the AV storage device 108 may include the unexpected pattern database. In another example, the unexpected pattern database is distinct from the AV storage device 108. By one approach, the registration of the identifier may enable a substantially faster identification of the unidentified AV(s) 118 at a next time. By another approach, the AV control circuit 102 may identify the unidentified AV(s) 118 based on the correlation of the one or more of the information previously stored in the AV storage device 108 of the previous encounters and/or determination of the unidentified AV(s) 118 and/or a determination of a threshold match of one or more identifiers attributable to the unidentified AV(s) 118 with a plurality of identifiers in the unexpected pattern database. In one configuration, the AV control circuit 102 may determine whether the one or more patterns of movement of the unidentified AV(s) 118 may have been previously identified by accessing the unexpected pattern database. In one example, the unexpected pattern database may store a plurality of patterns of movement of a plurality of unidentified AV(s) 118. In another example, each of the plurality of patterns of movement of the plurality of unidentified AV(s) 118 may be associated with a corresponding area of identification. By one approach, in response to the determination that the one or more patterns of movement of the unidentified AV has been previously identified, the AV control circuit 102 may determine whether an area of identification may be associated with the one or more patterns of movement of the unidentified AV(s) 118 and that the area may also be associated with other of the plurality of patterns of movement of the plurality of unidentified AV(s) 118. In one configuration, the AV control circuit 102 may determine whether the association to the area with the plurality of patterns of movement has reached a threshold. By one approach, the AV control circuit 102 may, in response to the threshold being reached, deviate from a portion of a delivery path associated with the delivery period to avoid the area. In one example, the avoided area may be stored in the unexpected pattern database and/or the AV storage device 108. In such an example, the first identified AV 104 may determine whether a particular area should be avoided based on a frequency of encounter of the unidentified AV(s) 118 by accessing the stored avoided area in the unexpected pattern database and/or the AV storage device 108. By one approach, the first identified AV 104 may send a request to the main control circuit 114 to deviate from the particular area based on a determination that the frequency of encounter is greater than a threshold. By another approach, the main control circuit 114 may access the unexpected pattern database and/or the AV storage device 108 prior to providing a delivery mission to the first identified AV 104 to determine whether the particular area should be avoided based on the determination that the frequency of encounter is greater than the threshold.

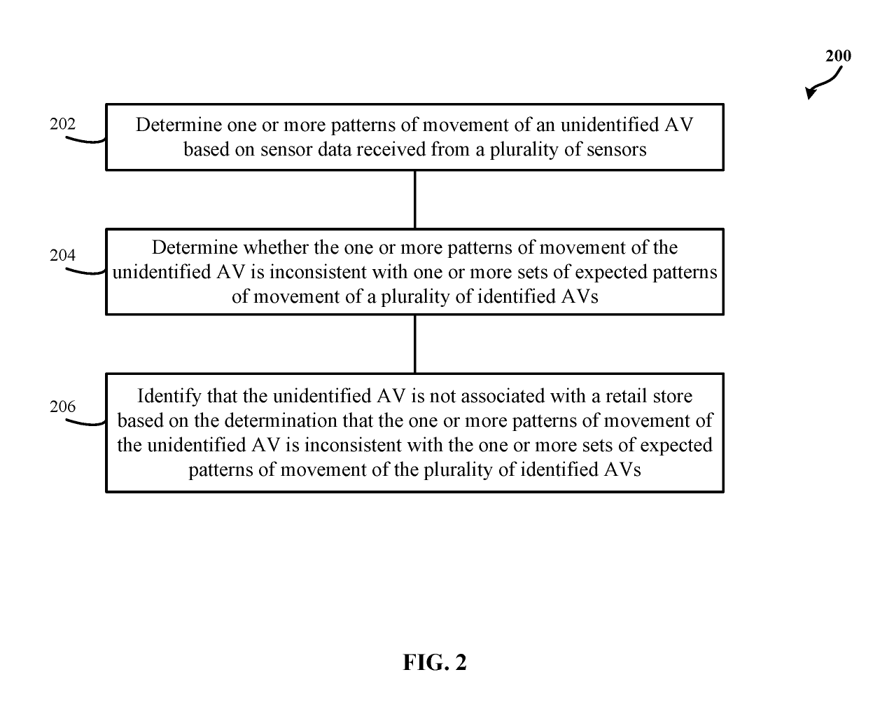

FIG. 2 illustrates a flow diagram of an exemplary method 200 for identifying and evaluating an unidentified autonomous vehicle. The exemplary method 200 may be implemented in the system 100 of FIG. 1. One or more steps in the method 200 may be implemented in the first identified AV 104, the AV control circuit 102, the plurality of sensors 106, the AV storage device 108, the main control circuit 114, and/or the other identified AVs 116 of FIG. 1. The method 200 includes, at step 202, determining one or more patterns of movement of an unidentified AV based on sensor data received from a plurality of sensors. By one approach, the first identified AV 104 may determine the one or more patterns of movement of the unidentified AV. In one example, the first identified AV 104 may transport one or more retail products associated with a retail store to a delivery destination within a delivery period. By one approach, the one or more retail products may be associated with a customer order. In one configuration, the method 200 may include, at step 204, determining whether the one or more patterns of movement of the unidentified AV is inconsistent with one or more sets of expected patterns of movement of a plurality of identified AVs. In such a configuration, the plurality of identified AVs may be associated with the retail store. In one example, the plurality of identified AVs may include the first identified AV 104 and/or the plurality of identified AVs 116. In another configuration, the method 200 may include identifying that the unidentified AV is not associated with the retail store based on the determination that the one or more patterns of movement of the unidentified AV is inconsistent with the one or more sets of expected patterns of movement of the plurality of identified AVs, at step 206.

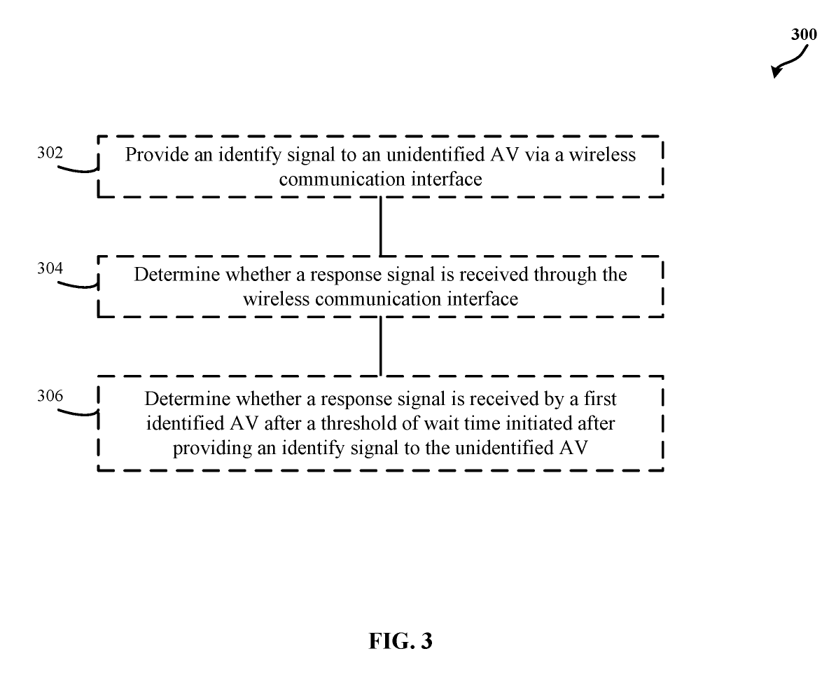

FIG. 3 illustrates a flow diagram of an exemplary method 300 for identifying and evaluating an unidentified autonomous vehicle. The exemplary method 300 may be implemented in the system 100 of FIG. 1. By one approach, one or more steps in the method 300 may be implemented in the first identified AV 104, the AV control circuit 102, the plurality of sensors 106, the AV storage device 108, the main control circuit 114, and/or the plurality of identified AVs 116 of FIG. 1. By another approach, the method 300 and/or one or more steps of the method may optionally be included in and/or performed in cooperation with the method 200 of FIG. 2. The method 300 includes, at step 302, providing an identify signal to an unidentified AV via a wireless communication interface. In one example, the wireless communication interface may include the wireless communication interface 112 of FIG. 1. In one configuration, the method 300 may include determining whether a response signal is received through the wireless communication interface, at step 304. By one approach, the identification that the unidentified AV is not associated with the retail store may be further based on the determination that the response signal is not received. In another configuration, the method 300 may include, at step 306, determining whether a response signal is received by a first identified AV after a threshold of wait time initiated after providing an identify signal to the unidentified AV. By one approach, the identification that the unidentified AV is not associated with the retail store may be further based on not receiving the response signal after the threshold of wait time.

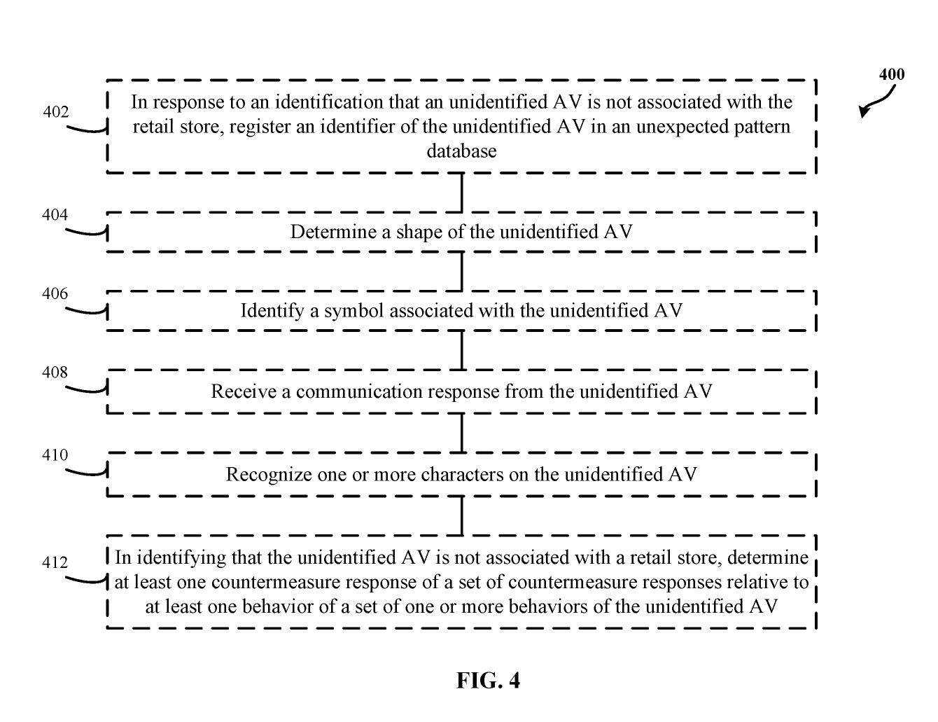

FIG. 4 illustrates a flow diagram of an exemplary method 400 for identifying and evaluating an unidentified autonomous vehicle. The exemplary method 400 may be implemented in the system 100 of FIG. 1. By one approach, one or more steps in the method 400 may be implemented in the first identified AV 104, the AV control circuit 102, the plurality of sensors 106, the AV storage device 108, the main control circuit 114, and/or the plurality of identified AVs 116 of FIG. 1. By another approach, the method 400 and/or one or more steps of the method may optionally be included in and/or performed in cooperation with the method 200 of FIG. 2 and/or the method 300 of FIG. 3. The method 400 includes, at step 402, registering an identifier of an unidentified AV in an unexpected pattern database in response to an identification that the unidentified AV is not associated with a retail store. By one approach, the registration of the identifier may enable a substantially faster identification of the unidentified AV at a next time. In one configuration, the method 400 may include, at step 404, determining a shape of an unidentified AV. In one example, the shape of the unidentified AV may enable identification of the unidentified AV. In another configuration, the method 400 may include, at step 406, identifying a symbol associated with an unidentified AV. In such a configuration, the symbol associated with the unidentified AV may enable identification of the unidentified AV. In another configuration, the method 400 may include, at step 408, receiving a communication response from an unidentified AV. By one approach, the receipt of the communication response may enable identification of the unidentified AV. In another configuration, the method 400 may include, at step 410, recognizing one or more characters on an unidentified AV. By one approach, the recognition of the one or more characters may enable identification of the unidentified AV. By another approach, at least one or more of the determination of the shape, the identification of the system, the receipt of the communication, and/or the recognition of the one or more characters on the unidentified AV may be performed prior to determining whether the one or more patterns of movement of the unidentified AV is inconsistent with one or more sets of expected patterns of movement of a plurality of identified AVs. Alternatively or in addition, the inconsistency of the one or more patterns of movement of the unidentified AV may be performed first. In yet another configuration, the method 400 may include, at step 412, determining at least one countermeasure response of a set of countermeasure responses relative to at least one behavior of a set of one or more behaviors of an unidentified AV in identifying that the unidentified AV is not associated with a retail store.

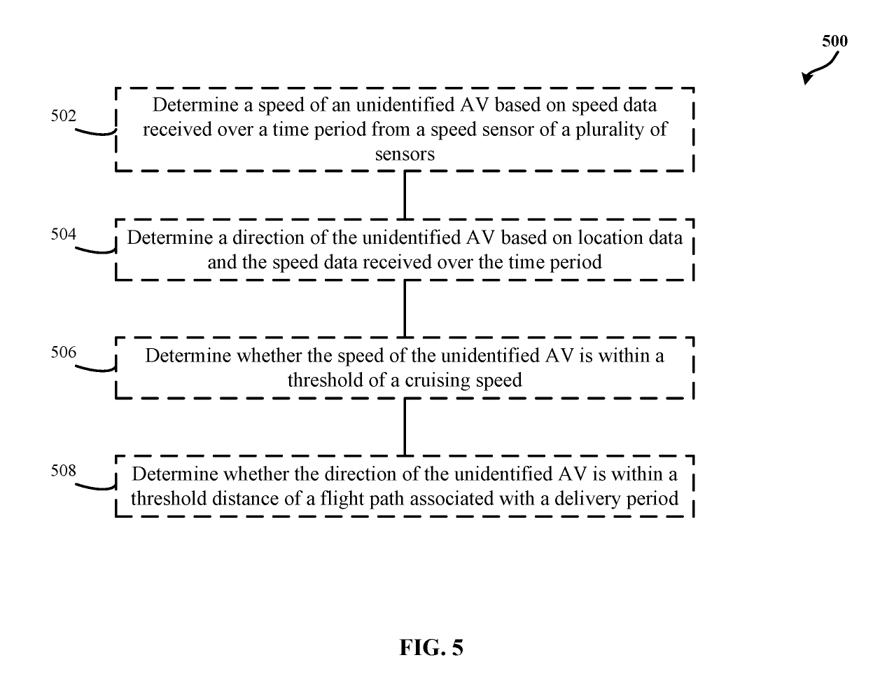

FIG. 5 illustrates a flow diagram of an exemplary method 500 for identifying and evaluating an unidentified autonomous vehicle. The exemplary method 500 may be implemented in the system 100 of FIG. 1. By one approach, one or more steps in the method 500 may be implemented in the first identified AV 104, the AV control circuit 102, the plurality of sensors 106, the AV storage device 108, the main control circuit 114, and/or the plurality of identified AVs 116 of FIG. 1. By another approach, the method 500 and/or one or more steps of the method may optionally be included in and/or performed in cooperation with the method 200 of FIG. 2, the method 300 of FIG. 3, and/or the method 400 of FIG. 4. The method 500 includes, at step 502, determining a speed of an unidentified AV based on speed data received over a time period from a speed sensor of a plurality of sensors. By one approach, the time period may be within a delivery period. In one example, in determining one or more patterns of movement of an unidentified AV, the speed of the unidentified AV may be determined. In another configuration, method 500 may include determining a direction of the unidentified AV based on location data and the speed data received over the time period, at step 504. By one approach, the sensor data may include the speed data and the location data. In another configuration, method 500 may include, at step 506, determining whether the speed of the unidentified AV is within a threshold of a cruising speed. In one example, the cruising speed may correspond to a predetermined speed corresponding to a movement associated with at least one expected pattern of one or more sets of expected patterns of movement of a plurality of identified AVs. In yet another configuration, method 500 may include determining whether the direction of the unidentified AV is within a threshold distance of a flight path associated with the delivery period, at step 508. By one approach, the determination that the one or more patterns of movement of the unidentified AV is inconsistent with the one or more sets of expected patterns of movement may be based on the determination that the speed of the unidentified AV is within the threshold of the cruising speed and the direction of the unidentified AV is within the threshold distance of the flight path.

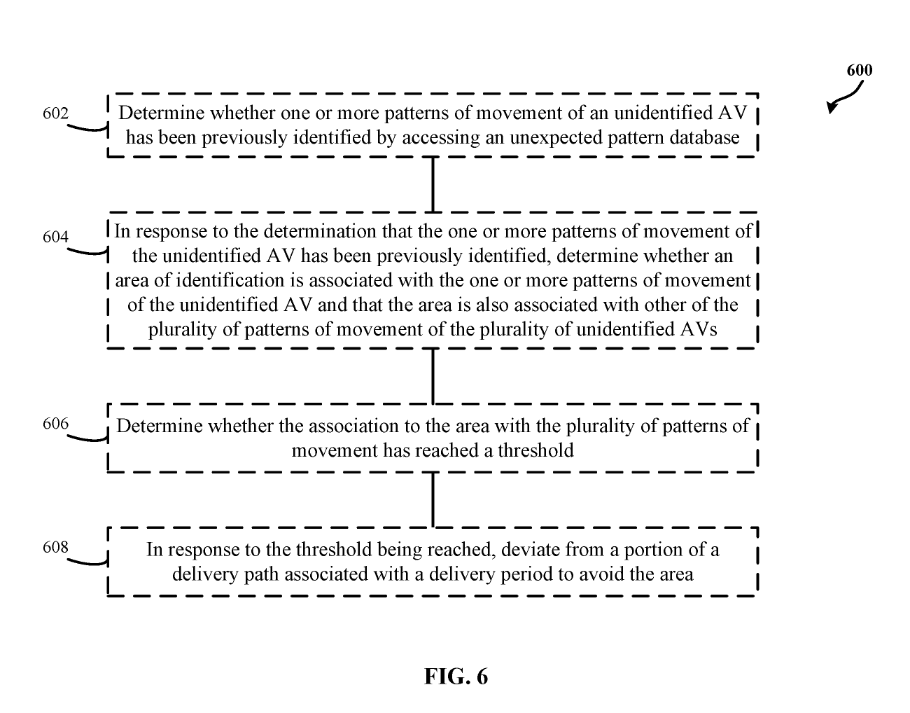

FIG. 6 illustrates a flow diagram of an exemplary method 600 for identifying and evaluating an unidentified autonomous vehicle. The exemplary method 600 may be implemented in the system 100 of FIG. 1. By one approach, one or more steps in the method 600 may be implemented in the first identified AV 104, the AV control circuit 102, the plurality of sensors 106, the AV storage device 108, the main control circuit 114, and/or the plurality of identified AVs 116 of FIG. 1. By another approach, the method 600 and/or one or more steps of the method may optionally be included in and/or performed in cooperation with the method 200 of FIG. 2, the method 300 of FIG. 3, the method 400 of FIG. 4, and/or the method 500 of FIG. 5. The method 600 includes, at step 602, determining whether one or more patterns of movement of an unidentified AV has been previously identified by accessing an unexpected pattern database. By one approach, the unexpected pattern database may store a plurality of patterns of movement of a plurality of unidentified AVs. In such an approach, each of the plurality of patterns of movement of the plurality of unidentified AVs may be associated with a corresponding area of identification. In one configuration, the method 600 may include determining whether an area of identification is associated with the one or more patterns of movement of the unidentified AV and that the area is also associated with other of the plurality of patterns of movement of the plurality of unidentified AVs in response to the determination that the one or more patterns of movement of the unidentified AV has been previously identified, at step 604. In another configuration, the method 600 may include, at step 606, determining whether the association to the area with the plurality of patterns of movement has reached a threshold. In yet another configuration, the method 600 may include, at step 608, in response to the threshold being reached, deviating from a portion of a delivery path associated with the delivery period to avoid the area.

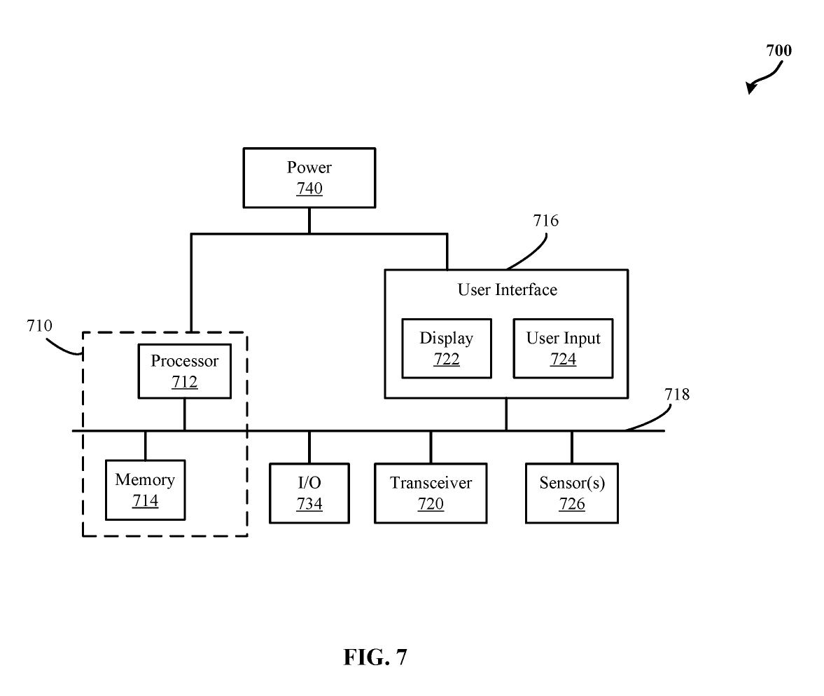

Further, the circuits, circuitry, systems, devices, processes, methods, techniques, functionality, services, servers, sources and the like described herein may be utilized, implemented and/or run on many different types of devices and/or systems. FIG. 7 illustrates an exemplary system 700 that may be used for implementing any of the components, circuits, circuitry, systems, functionality, apparatuses, processes, or devices of the system 100 of FIG. 1, the method 200 of FIG. 2, the method 300 of FIG. 3, the method 400 of FIG. 4, the method 500 of FIG. 5, the method 600 of FIG. 6, and/or other above or below mentioned systems or devices, or parts of such circuits, circuitry, functionality, systems, apparatuses, processes, or devices. For example, the system 700 may be used to implement some or all of the system for identifying and evaluating an unidentified autonomous vehicle during a retail product delivery by the first identified AV 104, the AV control circuit 102, the plurality of sensors 106, the AV storage device 108, the wireless communication interface 112, the main control circuit 114, the plurality identified AVs 116, the unidentified AV(s) 118, and/or other such components, circuitry, functionality and/or devices. However, the use of the system 700 or any portion thereof is certainly not required.

By way of example, the system 700 may comprise a processor module (or a control circuit) 712, memory 714, and one or more communication links, paths, buses or the like 718. Some embodiments may include one or more user interfaces 716, and/or one or more internal and/or external power sources or supplies 740. The control circuit 712 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 712 can be part of control circuitry and/or a control system 710, which may be implemented through one or more processors with access to one or more memory 714 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 700 may be used to implement one or more of the above or below, or parts of, components, circuits, systems, processes and the like. For example, the system 700 may implement the system 100 for identifying and evaluating an unidentified autonomous vehicle with the AV control circuit 102 being the control circuit 712.

The user interface 716 can allow a user to interact with the system 700 and receive information through the system. In some instances, the user interface 716 includes a display 722 and/or one or more user inputs 724, such as buttons, touch screen, track ball, keyboard, mouse, etc., which can be part of or wired or wirelessly coupled with the system 700. Typically, the system 700 further includes one or more communication interfaces, ports, transceivers 720 and the like allowing the system 700 to communicate over a communication bus, a distributed computer and/or communication network (e.g., a local area network (LAN), the Internet, wide area network (WAN), etc.), communication link 718, other networks or communication channels with other devices and/or other such communications or combination of two or more of such communication methods. Further the transceiver 720 can be configured for wired, wireless, optical, fiber optical cable, satellite, or other such communication configurations or combinations of two or more of such communications. Some embodiments include one or more input/output (I/O) interface 734 that allow one or more devices to couple with the system 700. The I/O interface can be substantially any relevant port or combinations of ports, such as but not limited to USB, Ethernet, or other such ports. The I/O interface 734 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 726 to provide information to the system and/or sensor information that is communicated to another component, such as the AV control circuit 102, the AV storage device 108, the wireless communication interface 112, the main control circuit 114, the plurality of identified AVs 116, the first identified AV 104, one or more sensors of the plurality of sensors 106, etc. The sensors can include substantially any relevant sensor, such as temperature sensors, distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting. In one configuration, the one or more sensors 726 may include one or more sensors of the plurality of sensors 106.

The system 700 comprises an example of a control and/or processor-based system with the control circuit 712. Again, the control circuit 712 can be implemented through one or more processors, controllers, central processing units, logic, software and the like. Further, in some implementations the control circuit 712 may provide multiprocessor functionality.

The memory 714, which can be accessed by the control circuit 712, typically includes one or more processor-readable and/or computer-readable media accessed by at least the control circuit 712, and can include volatile and/or nonvolatile media, such as RAM, ROM, EEPROM, flash memory and/or other memory technology. Further, the memory 714 is shown as internal to the control system 710; however, the memory 714 can be internal, external or a combination of internal and external memory. Similarly, some or all of the memory 714 can be internal, external or a combination of internal and external memory of the control circuit 712. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 714 can store code, software, executables, scripts, data, content, lists, programming, programs, log or history data, user information, customer information, product information, and the like. While FIG. 7 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A retail delivery control system for identifying and evaluating by an autonomous vehicle (AV) an unidentified autonomous vehicle during a retail product delivery comprising:
a first identified autonomous vehicle (AV) of a plurality of identified AVs configured to transport one or more retail products associated with a retail store to a delivery destination within a delivery period, wherein the one or more retail products are associated with a customer order, comprising:
a plurality of sensors configured to provide sensor data used to determine patterns of movement of AVs over a time period within the delivery period; and
an AV control circuit coupled with the plurality of sensors, the AV control circuit configured to:
receive the sensor data;
determine one or more patterns of movement of an unidentified AV based on the sensor data;
determine whether the one or more patterns of movement of the unidentified AV is inconsistent with one or more sets of expected patterns of movement of the plurality of identified AVs, wherein the plurality of identified AVs is associated with the retail store; and
identify that the unidentified AV is not associated with the retail store based on the determination that the one or more patterns of movement of the unidentified AV is inconsistent with the one or more sets of expected patterns of movement of the plurality of identified AVs.

2. The retail delivery control system of claim 1, wherein the AV control circuit is further configured to:
provide an identify signal to the unidentified AV via a wireless communication interface; and
determine whether a response signal is received through the wireless communication interface, wherein the identification that the unidentified AV is not associated with the retail store is further based on the determination that the response signal is not received.

3. The retail delivery control system of claim 1, wherein the AV control circuit is further configured to determine at least one countermeasure response of a set of countermeasure responses relative to at least one behavior of a set of one or more behaviors of the unidentified AV based on the identification that the unidentified AV is not associated with the retail store.

4. The retail delivery control system of claim 3, wherein the set of one or more behaviors of the unidentified AV comprises the unidentified AV intersecting with a flight path associated with the delivery period, the unidentified AV following and alongside a threshold distance from the flight path, causing the first identified AV to delay delivery to the delivery destination due to the unidentified AV substantially hovering over the flight path and proximate to the delivery destination, and the unidentified AV being less than a safe threshold distance from the first identified AV.

5. The retail delivery control system of claim 3, wherein the AV control circuit, in the determination of the at least one countermeasure response, is further configured to at least one of:
provide an alert message to a main control circuit communicatively coupled to the AV control circuit;
emit an alarm signal;
request modification of a portion of a flight path associated with the delivery period to the main control circuit; and
initiate landing on an AV landing site associated with the retail store.

6. The retail delivery control system of claim 5, further comprising the main control circuit remote from and in wireless communication with the first identified AV, the main control circuit configured to:
provide a first mission to the first identified AV via a wireless communication interface, wherein the first mission comprises the flight path; and
provide a deviation flight path, wherein the deviation flight path corresponds to the portion of the flight path modified by the main control circuit based on the request modification received from the first identified AV.

7. The retail delivery control system of claim 1, wherein the first identified AV further comprises an AV storage device coupled to the AV control circuit, the AV storage device configured to store the one or more sets of expected patterns of movement of the plurality of identified AVs, wherein the AV storage device is accessed by the AV control circuit during the determination of whether the one or more patterns of movement of the unidentified AV is inconsistent with the one or more sets of expected patterns of movement of the plurality of identified AVs.

8. The retail delivery control system of claim 1, wherein the plurality of sensors comprises a speed sensor configured to provide speed data of the unidentified AV and a location sensor configured to provide location data of the unidentified AV, and wherein the sensor data comprises the speed data and the location data.

9. The retail delivery control system of claim 8, wherein the AV control circuit, in the determination of the one or more patterns of movement of the unidentified AV, further comprises:
determine a speed of the unidentified AV based on the speed data received over the time period from the speed sensor; and
determine a direction of the unidentified AV based on the location data and the speed data received over the time period.

10. The retail delivery control system of claim 8, wherein the AV control circuit is further configured to:
determine whether the speed of the unidentified AV is within a threshold of a cruising speed, wherein the cruising speed corresponds to a predetermined speed corresponding to a movement associated with at least one expected pattern of the one or more sets of expected patterns of movement of the plurality of identified AVs; and
determine whether the direction of the unidentified AV is within a threshold distance of a flight path associated with the delivery period, wherein the determination that the one or more patterns of movement is inconsistent with the one or more sets of expected patterns of movement is based on the determination of the speed and the direction of the unidentified AV.

11. The retail delivery control system of claim 10, wherein the AV control circuit is further configured to determine whether a response signal is received by the AV control circuit after a threshold of wait time initiated after providing an identify signal to the unidentified AV, wherein the identification that the unidentified AV is not associated with the retail store is further based on not receiving the response signal after the threshold of wait time.

12. The retail delivery control system of claim 1, wherein the identification that the unidentified AV is not associated with the retail store is further based on at least one of: a shape of the unidentified AV, a symbol associated with the unidentified AV, a communication response from the unidentified AV, and a recognition of one or more characters on the unidentified AV.

13. A method for identifying and evaluating by an autonomous vehicle (AV) an unidentified autonomous vehicle during a retail product delivery comprising:
determining, by a first identified autonomous vehicle (AV) of a plurality of identified AVs, one or more patterns of movement of an unidentified AV based on sensor data received from a plurality of sensors, wherein the first identified AV is configured to transport one or more retail products associated with a retail store to a delivery destination within a delivery period, and wherein the one or more retail products are associated with a customer order;
determining, by the first identified AV, whether the one or more patterns of movement of the unidentified AV is inconsistent with one or more sets of expected patterns of movement of a plurality of identified AVs, wherein the plurality of identified AVs is associated with the retail store; and
identifying, by the first identified AV, that the unidentified AV is not associated with the retail store based on the determination that the one or more patterns of movement of the unidentified AV is inconsistent with the one or more sets of expected patterns of movement of the plurality of identified AVs.

14. The method of claim 13, further comprising:
providing an identify signal to the unidentified AV via a wireless communication interface; and
determining whether a response signal is received through the wireless communication interface, wherein the identification that the unidentified AV is not associated with the retail store is further based on the determination that the response signal is not received.

15. The method of claim 13, further comprising, in the identifying that the unidentified AV is not associated with the retail store, determining at least one countermeasure response of a set of countermeasure responses relative to at least one behavior of a set of one or more behaviors of the unidentified AV.

16. The method of claim 15, wherein the set of one or more behaviors of the unidentified AV comprises the unidentified AV intersecting with a flight path associated with the delivery period, the unidentified AV following and alongside a threshold distance from the flight path, causing the first identified AV to delay delivery to the delivery destination due to the unidentified AV substantially hovering over the flight path and proximate to the delivery destination, and the unidentified AV being less than a safe threshold distance from the first identified AV.

17. The method of claim 13, further comprising, in the determining of the one or more patterns of movement of the unidentified AV, wherein the sensor data comprises speed data and location data:
determining a speed of the unidentified AV based on the speed data received over a time period from a speed sensor of the plurality of sensors, wherein the time period is within the delivery period; and
determining a direction of the unidentified AV based on the location data and the speed data received over the time period.

18. The method of claim 17, further comprising:
determining whether the speed of the unidentified AV is within a threshold of a cruising speed, wherein the cruising speed corresponds to a predetermined speed corresponding to a movement associated with at least one expected pattern of the one or more sets of expected patterns of movement of the plurality of identified AVs; and
determining whether the direction of the unidentified AV is within a threshold distance of a flight path associated with the delivery period, wherein the determination that the one or more patterns of movement of the unidentified AV is inconsistent with the one or more sets of expected patterns of movement is based on the determination that the speed of the unidentified AV is within the threshold of the cruising speed and the direction of the unidentified AV is within the threshold distance of the flight path.

19. The method of claim 18, further comprising determining whether a response signal is received by the first identified AV after a threshold of wait time initiated after providing an identify signal to the unidentified AV, wherein the identification that the unidentified AV is not associated with the retail store is further based on not receiving the response signal after the threshold of wait time.

20. The method of claim 13, further comprising, in response to the identification that the unidentified AV is not associated with the retail store, registering an identifier of the unidentified AV in an unexpected pattern database, wherein the registration of the identifier enables a substantially faster identification of the unidentified AV at a next time.

21. The method of claim 13, further comprising:
determining whether the one or more patterns of movement of the unidentified AV has been previously identified by accessing an unexpected pattern database, wherein the unexpected pattern database is configured to store a plurality of patterns of movement of a plurality of unidentified AVs, and wherein each of the plurality of patterns of movement of the plurality of unidentified AVs is associated with a corresponding area of identification;
in response to the determination that the one or more patterns of movement of the unidentified AV has been previously identified, determining whether an area of identification is associated with the one or more patterns of movement of the unidentified AV and that the area is also associated with other of the plurality of patterns of movement of the plurality of unidentified AVs;
determining whether the association to the area with the plurality of patterns of movement has reached a threshold; and
in response to the threshold being reached, deviating from a portion of a delivery path associated with the delivery period to avoid the area.

22. The method of claim 13, wherein the identifying that the unidentified AV is not associated with the retail store is further based on at least one of: determining a shape of the unidentified AV, identifying a symbol associated with the unidentified AV, receiving a communication response from the unidentified AV, and recognizing one or more characters on the unidentified AV.
